(19) United States
(12) Patent Application Publication
(10) Pub. No.: US 2007/0040824 A1
(43) Pub. Date: Feb. 22, 2007

(54) Optical energy driven information display device

(76) Inventors: Li-Pai Chen, Chung-Ho City (TW); Shih-Che Lo, Chung Ho City (TW); Chi-Lu Chen, Chung Ho City (TW); Hsiang-An Hsieh, Hsintien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/358,094

(22) Filed: Feb. 22, 2006

(30) Foreign Application Priority Data
Aug. 19, 2005 (TW) 94214269

(51) Int. Cl. G09G 5/00

(52) U.S. Cl. 345/211

(57) ABSTRACT

An optical energy driven information display device comprises an information-display unit, an optical-to-electrical energy converter, and an electricity-control unit. Wherein the information-display unit includes a memory unit, a display unit, a display-control unit, and an information transmission control unit. The information transmission control unit transmits information to the memory unit, and the display control unit. The display-control unit electrically connects the display unit and the memory unit for displaying information in the display unit. The optical-to-electrical energy converter transforms light energy into electricity, and transmits the electric energy to the electricity-control unit, providing power to the information-display unit for displaying information.

### BACKGROUND OF THE INVENTION

1. Field of the Invention

The invention relates an information display device, and particularly relates to an information display device driven by light.

2. Description of Related Art

The information display device of prior art, usually supplies power to a display device via internal power supply. A low power-consuming device can generate enough power for a display device via a solar energy power-supplying device. For example, an electronic calculator having solar cells transforms light energy into electricity to supply the display device with power so that information can be displayed. A microprocessor unit of the electronic calculator receives a signal from a keystroke and processes calculation program, and then displays characters and calculated results on the display device.

However, the display device of the calculator is used for showing the operation status of the calculator. That is to say, after the microprocessor receives the operation signal, it directly displays information on the display device, and does not need to store information in the memory unit. The display immediately displays the information for the user. However, solar energy cannot be used to power the display device for indicating status information of a device, such as memory storage status information. Corresponding transmission control interface and memory element is needed to store and indicate pertaining information.

### SUMMARY OF THE INVENTION

The present invention provides an optical energy driven information display device, and uses an optical-to-electrical energy converter to provide electricity to an information display device for displaying various corresponding information.

An optical energy driven information display device comprises an information-display unit, an optical-to-electrical energy converter, and an electricity-control unit. Wherein the information-display unit includes a memory unit, a display unit, a display-control unit, and an information transmission control unit. The information transmission control unit transmits information to the memory unit, and the display control unit. The display-control unit electrically connects the display unit and the memory unit for displaying information in the display unit. The optical-to-electrical energy converter transforms optical energy into electricity, and supplies the electric energy to the electricity-control unit, providing power to the information-display unit for displaying information.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a block diagram showing the optical energy driven information display device according to a first exemplary embodiment of the present invention;

FIG. 2 is a block diagram showing the optical energy driven information display device according to a second exemplary embodiment of the present invention;

FIG. 2A is a block diagram showing the optical energy driven information display device operating in conditions with light according to a second exemplary embodiment of the present invention;

FIG. 2B is a block diagram showing the optical energy driven information device operating in conditions where there is no light according to a second exemplary embodiment of the present invention; and

FIG. 3 is a block diagram showing the optical energy driven information device according to a third exemplary embodiment of the present invention.

### DETAILED DESCRIPTION OF THE PREFERRED EMBODIMENTS

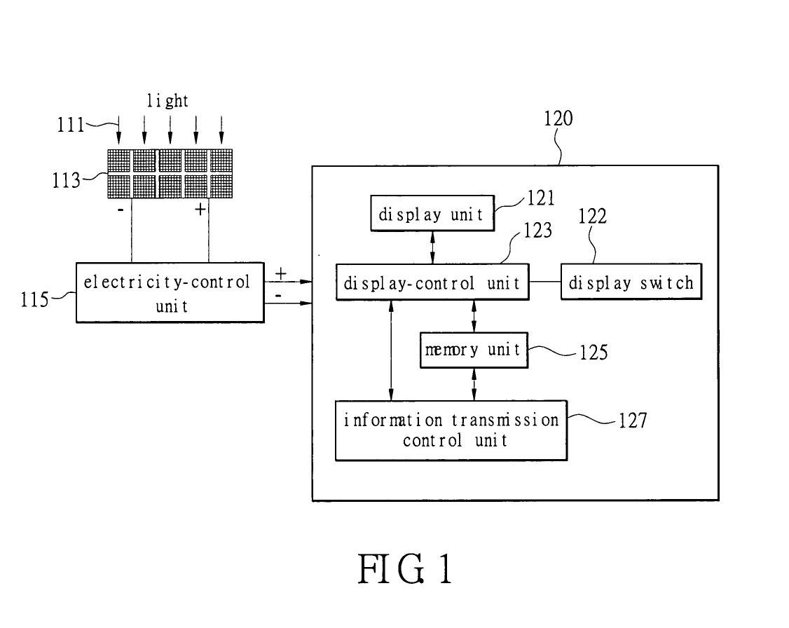

Please refer to FIG. 1, which shows a block diagram of the optical energy driven information display device according to a first exemplary embodiment of the present invention, the optical-to-electrical energy converter 113 receives light 111, and transforms the optical energy into the electrical energy. The electricity is then transmitted to an electricity-control unit 115, and the electricity is controlled via the electricity-control unit 115. Wherein the optical-to-electrical energy converter 113 can be a solar cell, receiving light from any kind of source of light, such as sunlight or a lamp, and transforms the optical energy into electricity. Wherein the electricity is controlled via the electricity-control unit 115.

The electricity-control unit 115 is electrically connected to the information-display unit 120, providing power to every unit in the information-display unit 120, and distributing power by step-up or step-down for achieving optimum power efficiency. The information transmission control unit 127 receives external information, and stores it in the memory unit 125, transmitting it directly to the display-control unit 123, and displays it via the display-control unit 123. The information received by the information transmission control unit 127 is transmitted to the display unit 121 via the display-control unit 123, and the display unit 121 displays the information. Wherein external information can be the stored information of an external memory, and the display unit 121 can be a liquid crystal display (LCD).

The foregoing the memory unit 125 can be a non-volatile memory or a volatile memory used for storing external information provided by the display-control unit 123 for reading, and then displays the external information on the display unit 121. When the optical-to-electrical energy converter 113 receives the light 111, it provides power on the one hand, and triggers the display-control unit 123 for displaying the external information on the display unit 121 on the other hand. Moreover, the display-control unit 123 can be switched via a display switch 122, and the display-control unit 123 reads the external information from the memory unit 125 and then displays it on the display unit 121.

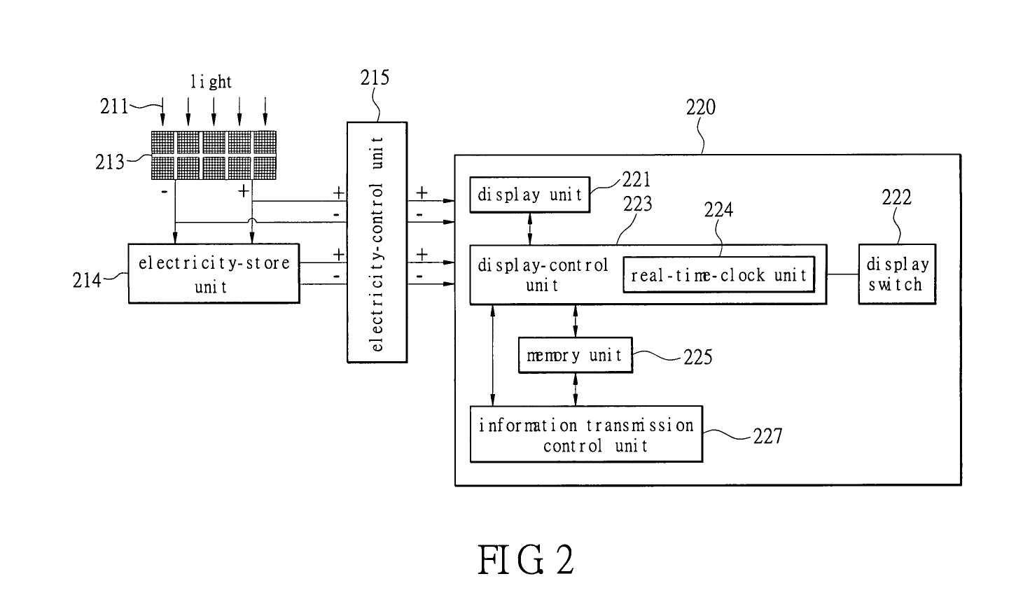

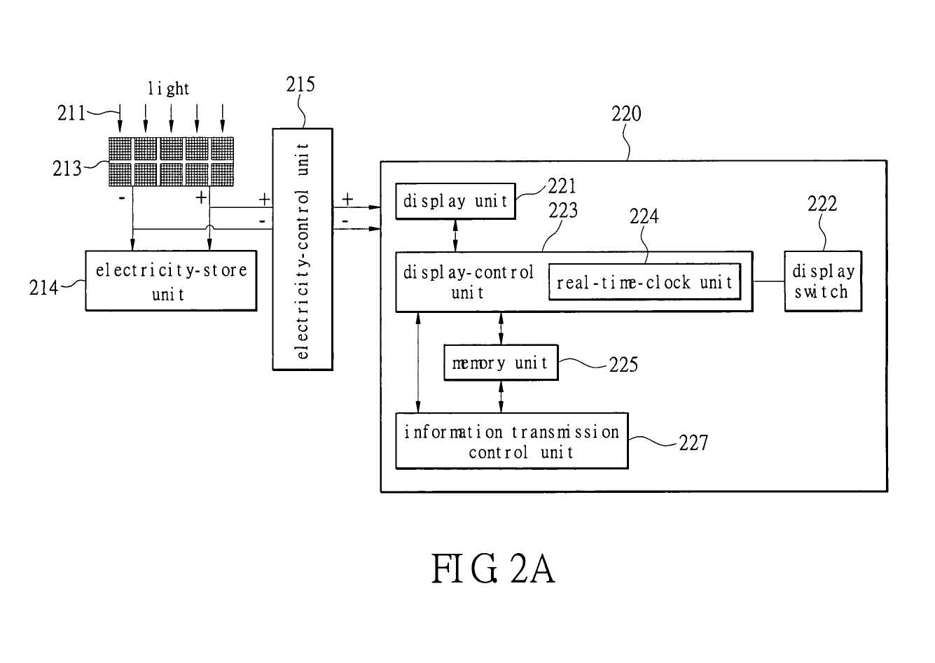

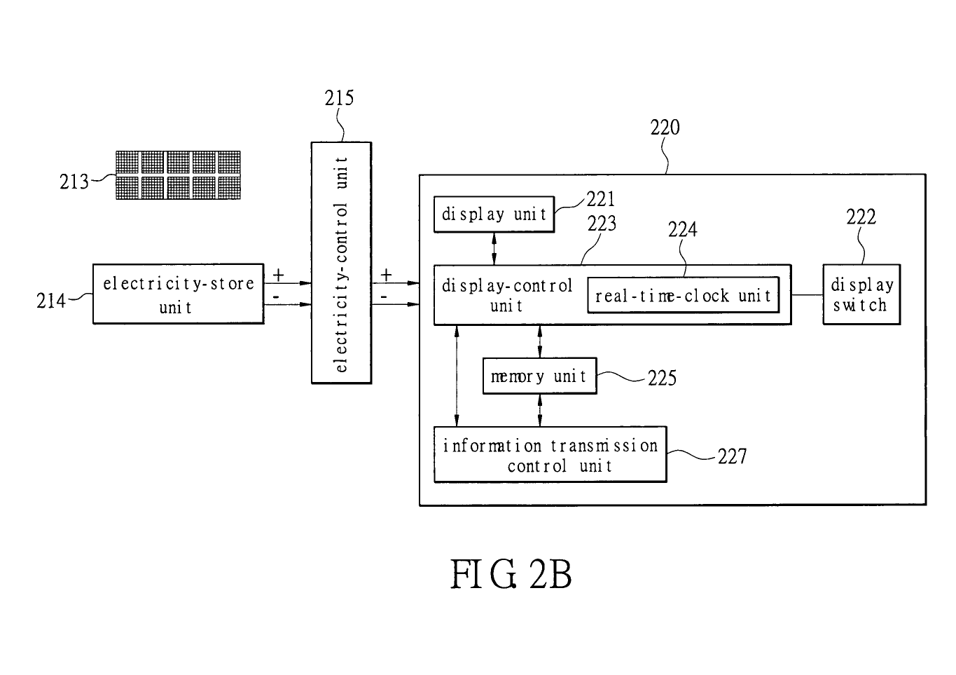

Please refer to FIG. 2, which is a block diagram showing the optical energy driven information display device according to a second exemplary embodiment of the present invention, wherein the optical-to-electrical energy converter 213 receives the light 211, and transforms the optical energy into electricity, and the optical-to-electrical energy converter 113 can be a solar cell. The optical-to-electrical energy converter 113 can transmit the electricity directly to the electricity-control unit 215, and the electricity stored in the electricity-control unit 215. The optical-to-electrical energy converter 113 also can store the electricity in the electricity-store unit 214, and the electricity-store unit 214 can be a capacitor battery or a storage battery, that is a rechargeable electricity store element. The information transmission control unit 227 is used for receiving the external information and storing it in the memory unit 225 and transmitting it to the display-control unit 223. Then the display-control unit 223 displays the information on the display unit 221. Wherein the external information can be the information stored in an external memory. The display-control unit 223 can be controlled via a display switch 222. The display-control unit 223 reads information for displaying on the display unit 221 when the display switch 222 is operated. Furthermore, the display-control unit 223 has a real-time-clock unit 224. The real-time-clock unit 224 is used for measuring present time, that is to say, the real-time-clock unit 224 is an internal unit for time measurement.

In the second exemplary embodiment the optical energy driven information display device is operated by energy converted from available source of light in the environment. In the case when a source of light is not available, the electricity-store unit 214 provides the power for operation. Please refer to FIG. 2A, which is a block diagram showing the optical energy driven information device operating in conditions when a source of light, that is a source of optical energy, is available, according to a second exemplary embodiment of the present invention. When the optical energy driven information display device operates in conditions with a source of light 211, the optical-to-electrical energy converter 213 receives the light 211 and transforms the light 211 to electricity. The electricity energy transmitted to the electricity-control unit 215 and disposed via the electricity-control unit 215 is for providing power to the information-display unit 220. The information control unit 223 reads the external information stored in the memory unit 225, and then displays information on the display unit 221. Wherein the display unit 221 is a liquid crystal display (LCD), and the electricity-control unit 213 can distribute power via step-up and step-down for attaining optimum power efficiency. Furthermore, the electric energy outputted from the optical-to-electrical energy converter 213 can be stored in electricity-store unit 214 for providing power to information-display unit 220 when the optical-to-electrical energy converter 213 losing the light 211.

Please refer to FIG. 2B, which is a block diagram showing the optical energy driven information device operating under conditions with no light according to a second exemplary embodiment of the present invention. When there is no light 211 provided to the optical-to-electrical energy converter 211, the power for the information-display unit 220 is provided by the electricity-store unit 214. The electric energy stored in the electricity-store unit 214 is transmitted to the electricity-control unit 215. The electric energy is held in the electricity-control unit 215 and distributed to the information-display unit 220 by the electricity-control unit 215. Wherein the memory unit 225 can be a non-volatile memory or a volatile memory. If the memory unit 225 is a volatile memory, the electricity stored in the electricity-store unit 214 is used to maintain the status of the memory unit 225 and the status of the display-control unit 223. However, no matter whether the memory unit 225 is a non-volatile memory or a volatile memory, in order to save power, the display unit 221 can be turned off, until it needs to display information, wherein the display-control unit 223 is turned on by the display switch 222. Then the display-control unit 223 reads the external information stored in the memory unit 225 and displays the information on the display unit 221.

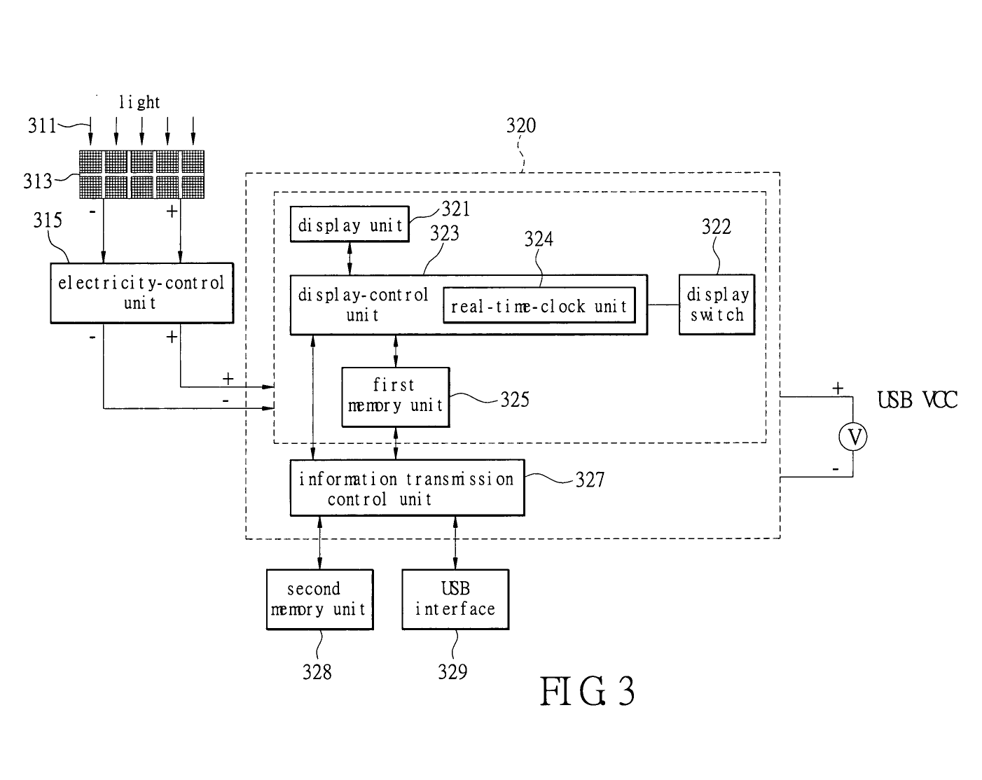

Please refer to FIG. 3, which is a block diagram showing the optical energy driven information device according a third exemplary embodiment of the present invention. The information transmission control unit 327 has a USB interface 329 that electrically connects to the second memory unit 328. Wherein the second memory unit 328 is either a hard disk or at least one non-volatile memory. The information transmission control unit 327 writes the information stored in the second memory unit 328 in the first memory unit 325, and transmits the information stored in the second memory unit 328 to the display-control unit 323, so that the display-control unit 323 displays the information in the display unit 321. Wherein the display unit 321 is a liquid crystal display (LCD) and the first memory unit 325 is a non-volatile memory for storing the information stored in the second memory 328 and providing information to the display-control unit 323 for reading. The display-control unit 323 has a real-time-clock unit 324 installed therein. The real-time-clock unit 324 is used for measuring present time, that is to say, the real-time-clock unit 324 is an internal unit for time measurement. The information transmission control unit 327 controls the information transmission between the second memory unit 328 and the external device (a computer or a host), and connects with the external device via the USB interface 329. Additionally, the display-control unit 323, the first memory unit 325 and the information transmission unit 327 can be integrated for displaying the information stored in the second memory unit 328 in the display unit 321 and controlling the information transmission between the second memory unit 328 and the external device.

When the information transmission control unit 327 connected with a host via the USB interface 329, the power for the information transmission control unit 327 and the information-display unit 320 is provided directly from the USB power interface 329 of the host. Furthermore, when the information transmission control unit 327 isn't connected to any external device, the optical-to-electrical energy converter 313 may receive light 311 from a light source, where the optical-to-electrical energy converter can be a solar cell. The optical energy is transformed into electricity, and the electricity is transmitted to the electricity-control unit 315 via the optical-to-electrical energy converter 313. According to the power demands of the information-display unit 320, the electricity-control unit 315 distributes power to the information-display unit 320 by controlling a set-up and a set-down for attaining optimum power efficiency.

For reducing power consumption, the display-control unit 323 can switch on by the display switch 322. Then the display-control unit 323 reads the information from the first memory unit 325 and displays the information on the display unit 321. Alternatively, when the optical-to-electrical energy converter 313 receives the light 311 from a light source, the optical-to-electrical energy converter 313 transforms the optical energy to electricity and transmits it to the electricity-control unit 315. Then the electricity-control unit 315 transmits the electricity to the information-display unit 320, so that the display-control unit 323 automatically reads the information from the first memory unit 325 and directly displays the information on the display unit 321. As such, a switch isn't required to display the information.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An optical energy driven information display device comprising:
an information-display unit, including:
a memory unit storing information;
a display unit displaying information;
a display-control unit electrically connecting the display unit and the memory unit, displaying information in the display unit; and
an information transmission control unit electrically connecting the memory unit and the display-control unit, transmitting information to the memory unit and the display-control unit;
a optical-to-electrical energy converter transforming optical energy into electricity; and
an electricity-control unit electrically connecting the optical-to-electrical energy converter and the information-display unit, for controlling and distributing the power.

2. The optical energy driven information display device as claimed in claim 1, further including an electricity storage unit, electrically connecting the optical-to-electrical energy converter and the electricity-control unit, for storing the electricity.

3. The optical energy driven information display device as claimed in claim 2, wherein the electricity storage unit is a capacitor battery.

4. The optical energy driven information display device as claimed in claim 2, wherein the electricity storage unit is a storage battery.

5. The optical energy driven information display device as claimed in claim 1, further including a display switch, the display unit displays information when the display switch is operated.

6. The optical energy driven information display device as claimed in claim 1, wherein when the optical-to-electrical energy converter receives light, and the display unit displays information.

7. The optical energy driven information display device as claimed in claim 1, wherein the displaying unit is a liquid crystal display (LCD).

8. The optical energy driven information display device as claimed in claim 1, wherein the optical-to-electrical energy converter is a solar cell.

9. The optical energy driven information display device as claimed in claim 1, wherein the memory unit is a volatile memory.

10. The optical energy driven information display device as claimed in claim 1, wherein the memory unit is a non-volatile memory.

11. An optical energy driven information display device comprising:
an information-display unit, including:
a memory unit storing information;
a display unit displaying information;
a display-control unit electrically connecting the display unit and the memory unit, having a real-time clock, displaying information in the display unit; and
an information transmission control unit electrically connecting the memory unit and the display-control unit, transmitting information to the memory unit and the display-control unit;
a optical-to-electrical energy converter transforming light energy into electricity; and
an electricity-control unit electrically connecting the optical-to-electrical energy converter and the information-display unit, for controlling and distributing the power.

12. The optical energy driven information display device as claimed in claim 11, wherein the real-time clock is used for counting time.

13. The optical energy driven information display device as claimed in claim 11, further including an electricity storage unit, electrically connecting the optical-to-electrical energy converter and the electricity-control unit, for storing the electricity.

14. The optical energy driven information display device as claimed in claim 13, wherein the electricity storage unit is a capacitor battery.

15. The optical energy driven information display device as claimed in claim 13, wherein the electricity storage unit is a storage battery.

16. The optical energy driven information display device as claimed in claim 11, further including a display switch, the display unit displays information when the display switch is operated.

17. The optical energy driven information display device as claimed in claim 11, wherein when the optical-to-electrical energy converter receives light, then the display unit displays information.

18. The optical energy driven information display device as claimed in claim 11, wherein the displaying unit is a liquid crystal display (LCD).

19. The optical energy driven information display device as claimed in claim 11, wherein the optical-to-electrical energy converter is a solar cell.

20. The optical energy driven information display device as claimed in claim 11, wherein the memory unit is a volatile memory.

21. The optical energy driven information display device as claimed in claim 11, wherein the memory unit is a non-volatile memory.

22. An optical energy driven information display device comprising:
an information-display unit, including:
a first memory unit storing information;
a display unit displaying information; and
a display-control unit electrically connecting the display unit and the first memory unit, having a real-time clock, displaying information of the first memory unit in the display unit;
an information transmission control unit electrically connecting a second memory unit, and transmitting information stored in the second memory unit to the first memory unit and the display-control unit;
a optical-to-electrical energy converter transforming light energy into electricity; and
an electricity-control unit electrically connecting the optical-to-electrical energy converter and the information-display unit, for controlling and distributing the power.

23. The optical energy driven information display device as claimed in claim 22, wherein the information transmission control unit transmits data via a USB interface.

24. The optical energy driven information display device as claimed in claim 22, wherein the real-time clock is used for counting time.

25. The optical energy driven information display device as claimed in claim 22, further including an electricity storage unit, electrically connecting the optical-to-electrical energy converter and the electricity-control unit, for storing the electricity.

26. The optical energy driven information display device as claimed in claim 25, wherein the electricity storage unit is a capacitor battery.

27. The optical energy driven information display device as claimed in claim 25, wherein the electricity storage unit is a storage battery.

28. The optical energy driven information display device as claimed in claim 22, further including a display switch, the display unit displays information when the display switch is operated.

29. The optical energy driven information display device as claimed in claim 22, wherein when the optical-to-electrical energy converter receives light, then the display unit displays information.

30. The optical energy driven information display device as claimed in claim 22, wherein the first memory unit is a non-volatile memory.

31. The optical energy driven information display device as claimed in claim 22, wherein the first memory unit is a volatile memory.

32. The optical energy driven information display device as claimed in claim 22, wherein the second memory unit has at least one non-volatile memory.

33. The optical energy driven information display device as claimed in claim 22, wherein the second memory unit is a hard disk.

34. The optical energy driven information display device as claimed in claim 22, wherein the displaying unit is a liquid crystal display (LCD).

35. The optical energy driven information display device as claimed in claim 22, wherein the optical-to-electrical energy converter is a solar cell.

36. An optical energy driven information display device comprising:
a display unit displaying information;
a control unit displaying information from a memory device in the display unit, including:
a first memory unit storing information;
a display-control unit electrically connecting the display unit and the first memory unit, having a real-time clock, displaying information in the display unit; and
an information transmission control unit electrically connecting a second memory unit, transmitting information stored in the second memory unit to the first memory unit and the display-control unit;
a optical-to-electrical energy converter transforming light energy into electricity; and
an electricity-control unit electrically connecting the optical-to-electrical energy converter, for controlling and distributing the power of the display unit and the control unit.

37. The optical energy driven information display device as claimed in claim 36, wherein the control unit transmits data via a USB interface.

38. The optical energy driven information display device as claimed in claim 36, wherein the real-time clock is used for counting time.

39. The optical energy driven information display device as claimed in claim 36, further including an electricity storage unit, electrically connecting the optical-to-electrical energy converter and the electricity-control unit, for controlling the electricity.

40. The optical energy driven information display device as claimed in claim 39, wherein the electricity storage unit is a capacitor battery.

41. The optical energy driven information display device as claimed in claim 39, wherein the electricity storage unit is a storage battery.

42. The optical energy driven information display device as claimed in claim 39, further including a display switch, the display unit displays information when the display switch is operated.

43. The optical energy driven information display device as claimed in claim 36, wherein when the optical-to-electrical energy converter receives light, then the display unit displays information.

44. The optical energy driven information display device as claimed in claim 36, wherein the first memory unit is a non-volatile memory.

45. The optical energy driven information display device as claimed in claim 36, wherein the first memory unit is a volatile memory.

46. The optical energy driven information display device as claimed in claim 36, wherein the second memory unit has at least one non-volatile memory.

47. The optical energy driven information display device as claimed in claim 36, wherein the second memory unit is a hard disc.

48. The optical energy driven information display device as claimed in claim 36, wherein the displaying unit is a liquid crystal display (LCD).

49. The optical energy driven information display device as claimed in claim 36, wherein the optical-to-electrical energy converter is a solar cell.
